(19) United States
(12) Patent Application Publication
(10) Pub. No.: US 2025/0388280 A1
(43) Pub. Date: Dec. 25, 2025

(54) Transport Cart and Transport Facility

(71) Applicant: Daifuku Co., Ltd., Osaka-shi (JP)

(72) Inventors: Kazuhiko Miyoshi, Osaka-shi (JP); Kozo Hasegawa, Tokyo (JP)

(21) Appl. No.: 19/247,017

(22) Filed: Jun. 24, 2025

(30) Foreign Application Priority Data
Jun. 25, 2024 (JP) 2024-102136

(51) Int. Cl. B62D 65/18; B66F 9/02; G05D 1/244

(52) U.S. Cl. CPC B62D 65/18; B66F 9/02; G05D 1/244

(57) ABSTRACT

A transport cart includes a first cart, a second cart arranged in parallel with the first cart, and a frame. The first cart and the second cart are away from each other in a Y-direction. The frame includes a first standing section extending upward from the first cart, a second standing section extending upward from the second cart, a coupler placed above the first cart and the second cart and coupling the first standing section with the second standing section in the Y-direction, and a plurality of supports placed above the first cart and the second cart and configured to support a transport object from below. The plurality of supports is away from each other in at least either an X-direction or the Y-direction.

### CROSS-REFERENCE TO RELATED APPLICATION

This application claims priority to Japanese Patent Application No. 2024-102136 filed Jun. 25, 2025, the disclosure of which is hereby incorporated by reference in its entirety.

### BACKGROUND OF THE INVENTION

### 1. Field of the Invention

The present invention relates to a transport cart and a transport facility.

### 2. Description of Related Art

For example, Japanese Unexamined Patent Application Publication No. 2012-121650 (JP 2012-121650) discloses a technology related to a transport cart and a transport facility. Hereinafter, reference signs in parentheses in the Description of the Related Art are reference signs in JP 2012-121650.

A transport cart in JP 2012-121650 includes a plurality of supports (transport article supports 3, 4) configured to support a transport object (a transport article W) from below, and a cart (a body 2A, wheels 5, 6) provided with the plurality of supports. The plurality of supports is provided to extend upward from the top surface of the cart and is arranged away from each other. The transport cart is configured to be coupled with a tow transport vehicle (a tractor 1) including a drive source. The transport cart is towed by the tow transport vehicle so as to move on a travel path.

Generally, the transport cart as described above performs some operation on the transport object (for example, an operation for assembling a component to the transport object or the like) at the same time as transport of the transport object. Since the transport object is placed on the cart of the transport cart, an operation on a lateral surface of the transport object is easily performable, but an operation on a bottom surface of the transport object is not easily performable due to the cart being obstructive. Accordingly, in a case where an operation is performed on the bottom surface of the transport object, it is necessary to transfer the transport object from the transport cart onto another cart (for example, a transport cart having a function to lift and lower the transport object, an overhead transport vehicle configured to hold the transport object in a hanging manner, or the like) or a support (for example, a support including a lifting and lowering device or the like). Such an additional operation for transferring the transport object onto another cart or the like depending on an operation target portion of the transport object or an operation content for the transport object easily decreases working efficiency, thereby decreasing convenience of using the transport cart.

### SUMMARY OF THE INVENTION

In view of the foregoing, a technology that can achieve an improvement in the convenience of a transport cart for transporting a transport object is desired.

A transport cart according to this disclosure is a transport cart including a first cart, a second cart arranged in parallel with the first cart, and a frame. The first cart and the second cart are away from each other in a Y-direction perpendicular to an X-direction as viewed vertically along an up-down direction, the X-direction being a particular direction among directions along a horizontal surface. The frame includes a first standing section extending upward from the first cart, a second standing section extending upward from the second cart, a coupler placed above the first cart and the second cart and coupling the first standing section with the second standing section in the Y-direction, and a plurality of supports placed above the first cart and the second cart and configured to support a transport object from below. The plurality of supports is away from each other in at least either the X-direction or the Y-direction.

In this configuration, the first cart and the second cart are away from each other in the Y-direction, which allows the transport cart to travel in such a manner that various devices or equipment can pass between the first cart and the second cart in the Y-direction as viewed from the transport cart. Accordingly, this transport cart can be easily used in various transport facilities or manufacturing facilities.

In addition, in this configuration, the plurality of supports is placed above the first cart and the second cart and supports the transport object from below. Accordingly, an operation space can be easily secured below the transport object supported by these supports. The plurality of supports is away from each other in at least either the X-direction or the Y-direction. Accordingly, a region of the bottom surface of the transport object which region is covered with the supports can be made small, thereby making it possible to easily perform an operation on the transport object from below. In consideration of such a point, this transport cart can be easily used in various transport facilities or manufacturing facilities.

As such, with this configuration, it is possible to achieve an improvement in the convenience of the transport cart for transporting a transport object.

Further features and advantages of the transport cart and the transport facility are made clear from the following description on exemplary and nonlimiting embodiments to be described with reference to the drawings.

### BRIEF DESCRIPTION OF THE DRAWINGS

FIG. 1 is a whole schematic diagram of a transport facility;

FIG. 2 is a perspective view of a transport cart and a transfer device;

FIG. 3 is a front view schematically illustrating the arrangement of a tow transport vehicle and the transport cart;

FIG. 4 is a front view of the transport cart;

FIG. 5 is a plan view of the transport cart;

FIG. 6 is a side view of the transport cart;

FIG. 7 is a control block diagram;

FIG. 8 is a perspective view of a transport cart according to another embodiment; and

FIG. 9 is a perspective view of a transport cart according to another embodiment.

### DESCRIPTION OF THE INVENTION

### First Embodiment

The following describes a first embodiment of a transport cart and a transport facility with reference to the drawings.

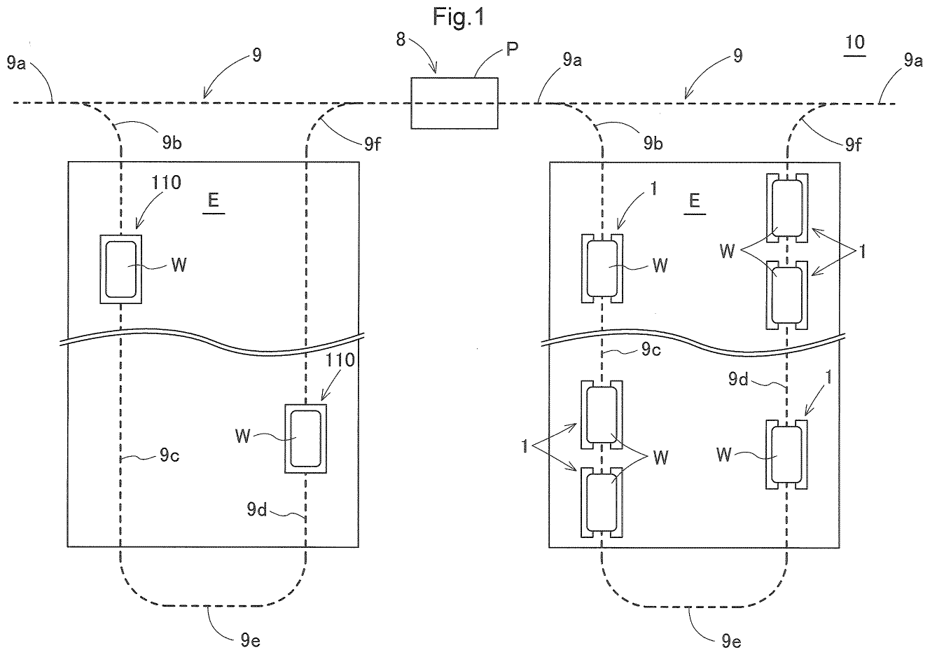

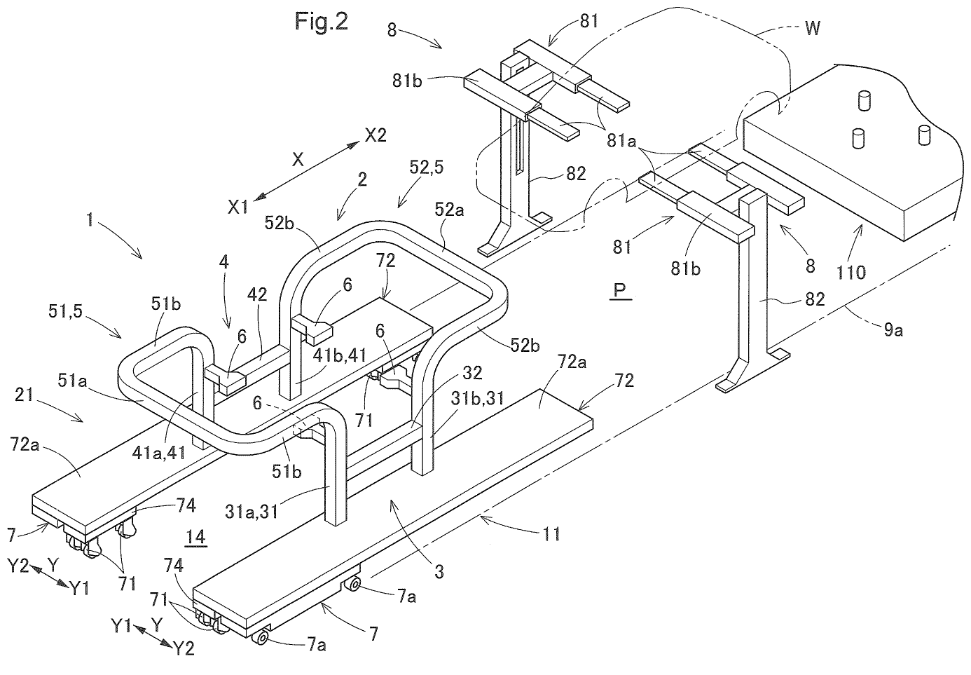

As illustrated in FIGS. 1, 2, a transport facility 10 includes a transport cart 1, and a transfer device 8 configured to transfer a transport object W onto the transport cart 1 at a predetermined position. The transport facility 10 includes a path 9 on which a plurality of transport objects W moves. The transport cart 1 is configured to be movable along the path 9 while supporting the transport object W. Here, the transport facility 10 includes a plurality of transport carts 1. The plurality of transport carts 1 sequentially moves along the path 9 with one transport object W being placed (supported) on each of the plurality of transport carts 1. In the present example, the transport facility 10 further includes a plurality of work section E, a plurality of mobile carts 110 different from the transport carts 1, and a control device H configured to control the whole transport facility 10. The control device H controls various devices or the like in the transport facility 10. The control device H includes a processor such as a microcomputer, a peripheral circuit such as a memory, and so on, for example. In collaboration of such hardware with a program executed on a processor of a computer or the like, each function as the control device H is implemented.

In the example of FIG. 1, the path 9 includes a first connection path 9a connecting work sections E adjacent to each other, a branch path 9b branching from the first connection path 9a, a merging path 9f merging with the first connection path 9a, a first internal path 9c extending from the branch path 9b into the work section E, a second internal path 9d adjacent to the first internal path 9c in the work section E and connected to the merging path 9f, and a second connection path 9e connecting the first internal path 9c to the second internal paths 9d. The transport object W is supported by the transport cart 1 or the mobile cart 110 and moves in order of the first connection path 9a, the branch path 9b, the first internal path 9c, the second connection path 9e, the second internal path 9d, the merging path 9f, and the first connection path 9a. In the example illustrated herein, different carts are used in two work sections E adjacent to each other to support the transport object W. More specifically, in one of the work sections E, the transport object W is transported by the mobile cart 110, and in the other one of the work sections E, the transport object W is transported by the transport cart 1. In FIG. 1, the transfer device 8 is placed along the first connection path 9a connecting the two work sections E adjacent to each other. The transport object W is transferred by the transfer device 8 from the mobile cart 110 to the transport cart 1 on the first connection path 9a. That is, in the present example, the predetermined position (a transfer position P) is a position on a path connecting the work sections E adjacent to each other.

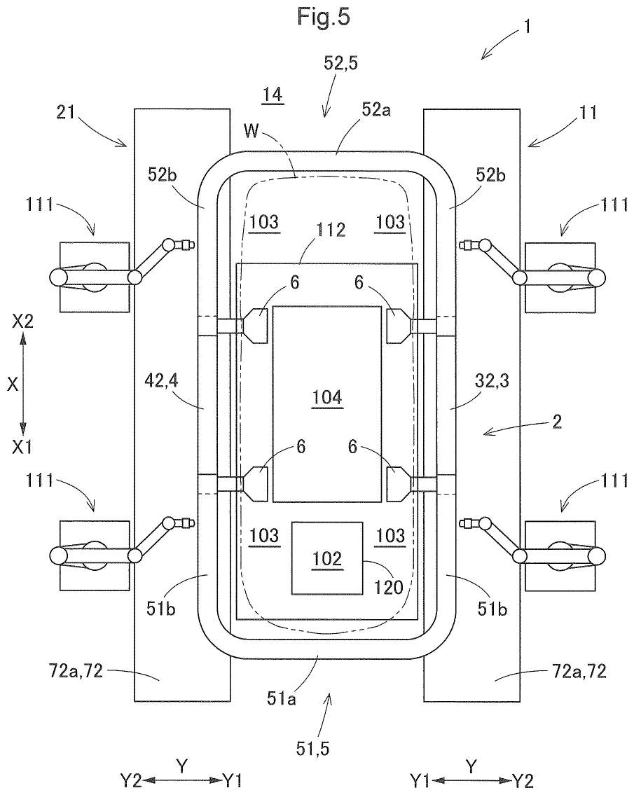

In the present example, as illustrated in FIGS. 4 to 7, the transport facility 10 includes an assembly device 111 and a transport device 112. The assembly device 111 is a robot configured to assemble a component (an assembling component 120) to the transport object W. The transport device 112 is a device configured to transport the assembling component 120. A plurality of such devices is placed in the work section E illustrated in FIG. 1. The assembly device 111 and the transport device 112 may be placed to correspond to each of the first internal path 9c and the second internal path 9d or may be placed in either one of these paths. Here, as illustrated in FIGS. 4, 5, the assembly device 111 is a robot configured to perform an operation laterally on the transport object W. The transport device 112 is a cart configured to transport a plurality of assembling components 120 with the plurality of assembling components 120 being placed on the transport device 112 (supported from below). The transport device 112 has a function to lift and lower the assembling component 120. Here, the transport device 112 is a cart that can travel along at least part of the first internal path 9c and the second internal path 9d. Each of the work sections E can include an operator area for an operator to perform an operation on the transport object W. In the present embodiment, the transport object W is a body of an automobile. In the work section E, the assembling component 120 such as a drive force source, a battery, a wheel, or a suspension, for example, is assembled to the body of the automobile. Here, the “drive force source” is a drive force source for traveling wheels of the automobile and can be an electric machine or an internal combustion engine. Such an assembling operation is performed by the aforementioned device (the assembly device 111, the transport device 112) or is performed by a manpower. Note that, in the following description, an X-direction is a particular direction among directions along a horizontal surface, and a Y-direction is a direction perpendicular to the X-direction as viewed vertically along an up-down direction. A first side X1 in the X-direction indicates one side in the X-direction, and a second side X2 in the X-direction is the other side in the X-direction. In the present embodiment, the X-direction is a direction along the longitudinal direction of the body. In addition, the X-direction is the movement direction of the transport cart 1 (a direction along the path 9). In the present example, the first side X1 in the X-direction is forward in the movement direction of the transport cart 1, and the second side X2 in the X-direction is rearward in the movement direction of the transport cart 1.

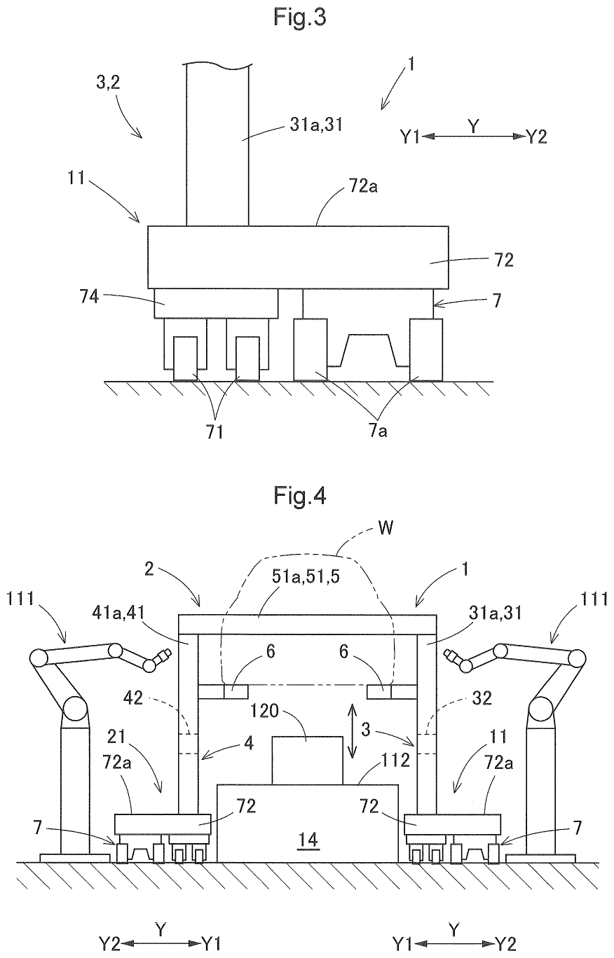

In the present embodiment, the transport cart 1 includes no drive source. As illustrated in FIGS. 3, 6, and 7, the transport facility 10 includes a tow transport vehicle 7 including a drive source. The transport cart 1 is configured to be towed by the tow transport vehicle 7 to move on the path 9. The tow transport vehicle 7 includes, for example, an electric motor (not illustrated) as the drive source, travel wheels 7a configured to roll on a floor surface by a driving force from the electric motor, and a control unit (not illustrated) configured to control the traveling of the tow transport vehicle 7. The tow transport vehicle 7 is communicable with the control device H. In the present example, a guide section (herein, a magnetic tape (not illustrated)) configured to guide the tow transport vehicle 7 along the path 9 is placed. The tow transport vehicle 7 is guided by the magnetic tape provided on the floor surface and travels on the path 9. That is, the tow transport vehicle 7 further includes a reader (not illustrated) configured to read the magnetic tape. Hereby, the transport cart 1 can move on the path 9. The tow transport vehicle 7 can transmit positional information or the like on the tow transport vehicle 7 to the control device H. The tow transport vehicle 7 travels inside and outside the work section E based on command information acquired from the control device H. In the present embodiment, the tow transport vehicle 7 is attachable to and detachable from the transport cart 1.

The mobile cart 110 is configured to be movable on the path 9 with the transport object W being placed on the mobile cart 110. In the present example, the mobile cart 110 includes no drive source, and the mobile cart 110 is towed by the tow transport vehicle 7 to move on the path 9. The mobile cart 110 is attachable to and detachable from the tow transport vehicle 7. Note that the mobile cart 110 may include a drive source such as an electric motor so that the mobile cart 110 can travel by itself.

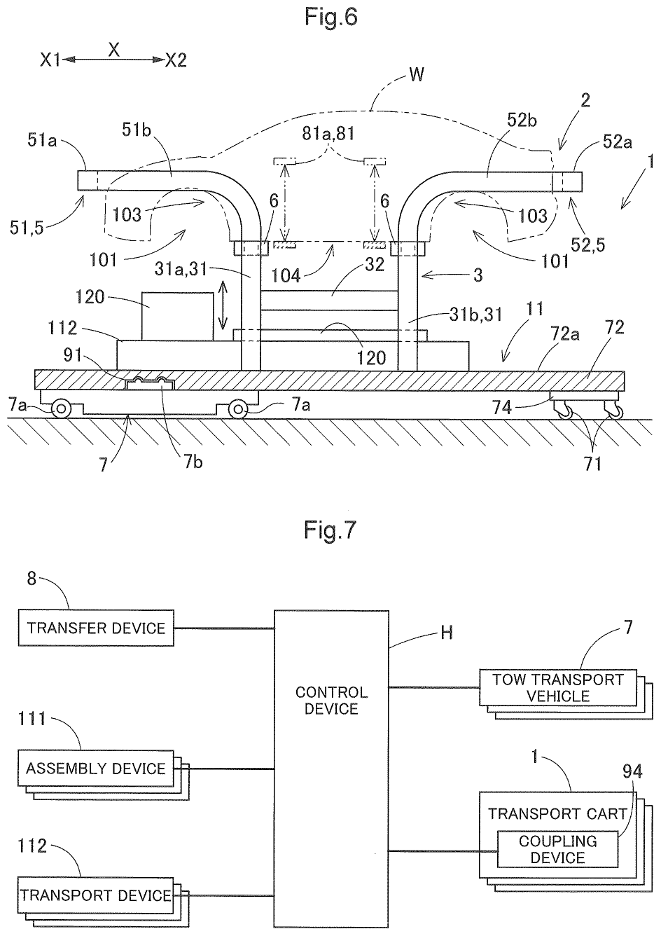

As illustrated in FIGS. 2, 7, the transfer device 8 includes a transfer support 81 configured to support the transport object W from below, and a lifting and lowering mechanism 82 configured to lift and lower the transfer support 81. The transfer device 8 is configured to transfer the transport object W onto a plurality of supports 6 in such a manner that the transfer support 81 supporting the transport object W is lowered toward the plurality of supports 6 from above. In the present example, the transfer support 81 includes a fork section 81a retractable horizontally (here, in the Y-direction), and a support body 81b configured to store the fork section 81a. The fork section 81a supports the transport object W from below at a projecting position (in which the fork section 81a projects from the support body 81b). The lifting and lowering mechanism 82 has a function to lift and lower the transfer support 81 and also functions as a member supporting the transfer support 81. In the example illustrated herein, a plurality of transfer devices 8 is placed at the transfer position P to sandwich the first connection path 9a from outside. The transfer devices 8 receive the transport object W from the mobile cart 110 stopping at the transfer position P and transfer it to the transport cart 1. Herein, the transport object W placed on the mobile cart 110 is scooped by respective transfer supports 81 of the transfer devices 8 sandwiching the first connection path 9a from outside. The transport object W is lifted to a position higher than the transport cart 1 by the transfer devices 8. The mobile cart 110 transferring the transport object W to the transfer devices 8 moves from the transfer position P. After that, an empty transport cart 1 (the transport cart 1 on which no transport object W is placed) moves to the transfer position P and stops. The transfer devices 8 lower the transfer supports 81 supporting the transport object W and put the transport object W onto the plurality of supports 6 of the transport cart 1 (FIG. 6). Such a transfer operation performed by the transfer devices 8 is controlled by the control device H. A detailed configuration of the transport cart 1 will be described below.

As illustrated in FIGS. 2 to 6, the transport cart 1 includes a first cart 11, a second cart 21 arranged in parallel with the first cart 11, and a frame 2. The first cart 11 and the second cart 21 are away from each other in the Y-direction. The frame 2 connects the first cart 11 to the second cart 21 and supports the transport object W. In the present embodiment, the first cart 11 and the second cart 21 are away from each other in the Y-direction. A gap 14 between the first cart 11 and the second cart 21 has a dimension through which a device or the like (herein, the transport device 112) that performs an operation on the transport object W can pass. That is, the dimension of the gap 14 in the Y-direction is larger than the dimension of the transport device 112 in the Y-direction (the dimension thereof in the width direction). Note that the size of the gap 14 is changeable appropriately. The frame 2 is placed at a position where the frame 112 does not make contact with the assembly device 111 or the transport device 112.

In the present example, the first cart 11 and the second cart 21 have the same configuration. Accordingly, the following describes details of the configuration of the first cart 11 and does not describe the configuration of the second cart 21. The first cart 11 includes wheels 71 configured to roll on the floor surface, and a cart body 72 supporting the wheels 71. The cart body 72 is a plate-shaped member extending in the X-direction and holds the wheels 71 from above. Herein, the wheels 71 are attached to a wheel holder 74. Hereby, the cart body 72 holds the wheels 71 via the wheel holder 74. The first cart 11 includes a plurality of wheels 71. In the present example, the plurality of wheels 71 is away from each other in the X-direction. The cart body 72 has a top surface 72a that is a flat surface so that the operator can work on the cart body 72.

As illustrated in FIG. 6, each of the first cart 11 and the second cart 21 includes a tow coupler 91 to be coupled with the tow transport vehicle 7 including the drive source. The tow coupler 91 is attachable to and detachable from the tow transport vehicle 7. In the present example, the tow coupler 91 is provided for the cart body 72. Here, the tow coupler 91 is provided for a surface of the cart body 72 which surface faces downward. The tow coupler 91 is engageable with a first engagement section 7b provided for the top surface of the tow transport vehicle 7 (FIG. 6). That is, the tow coupler 91 functions as a second engagement section engageable with the first engagement section 7b. In the present example, the tow transport vehicle 7 has a mechanism configured to lift and lower the first engagement section 7b. Due to a reaction force received by the tow transport vehicle 7 from the cart body 72 with the first engagement section 7b being lifted and engaged with the tow coupler 91, the travel wheels 7a of the tow transport vehicle 7 are pressed against the floor surface, so that a large frictional force between the travel wheels 7a and the floor surface is secured. Hereby, a large driving force by the tow transport vehicle 7 is secured. In the present embodiment, the tow coupler 91 is attachable to and detachable from the first engagement section 7b. In a case where the transport cart 1 is moved along the path 9, the tow transport vehicle 7 is coupled with the tow coupler 91. In the present example, in the cart body 72, the tow coupler 91 is placed forward (on the first side X1 in the X-direction) from column supports (a front first column support 31a, a front second column support 41a), but the present invention is not limited to this. A position where the tow coupler 91 is provided is changeable appropriately. Note that an obstacle sensor for avoiding a collision between a plurality of transport carts 1 towed by the tow transport vehicle 7 may be provided for the tow transport vehicle 7 or may be provided for the transport cart 1.

In the present example, the transport cart 1 is towed by respective tow transport vehicles

7 provided for the first cart 11 and the second cart 21. Herein, each of the first cart 11 and the second cart 21 is provided with one tow transport vehicle 7. Note that only one of the first cart 11 and the second cart 21 may be provided with the tow transport vehicle 7. As described above, the tow transport vehicle 7 is attachable to and detachable from the transport cart 1. Accordingly, the transport cart 1 can be transported by a device other than the tow transport vehicle 7. For example, the transport cart 1 may be transported by a conveyor provided for a work section.

As illustrated in FIGS. 2 to 6, the frame 2 includes a first standing section 3 extending upward from the first cart 11, a second standing section 4 extending upward from the second cart 21, a coupler 5 placed above the first cart 11 and the second cart 21 and coupling the first standing section 3 with the second standing section 4 in the Y-direction, and a plurality of supports 6 placed above the first cart 11 and the second cart 21 and configured to support the transport object W from below. In the present embodiment, the plurality of supports 6 is provided for each of the first standing section 3 and the second standing section 4. In the present example, the first standing section 3 is fixed to the cart body 72 of the first cart 11. Similarly, the second standing section 4 is fixed to the cart body 72 of the second cart 21. Herein, the first standing section 3 includes a plurality of first column supports 31. Similarly, the second standing section 4 includes a plurality of second column supports 41.

As illustrated in FIG. 2 and FIGS. 4 to 6, the first standing section 3 includes a pair of first column supports 31 away from each other in the X-direction. The first standing section 3 also includes a first beam 32 coupling the pair of first column supports 31 with each other. The second standing section 4 includes a pair of second column supports 41 away from each other in the X-direction. The second standing section 4 also includes a second beam 42 coupling the pair of second column supports 41 with each other. In the present example, the first beam 32 and the second beam 42 are placed along the X-direction. These beams are placed above the first cart 11 and the second cart 21 but below the plurality of supports 6.

As illustrated in FIGS. 2, 6, in the present embodiment, each of the first standing section 3 and the second standing section 4 does not overlap with a region (a first region 101) in which a wheel of the automobile is to be provided, as viewed in the Y-direction. Naturally, the first region 101 includes a wheel arrangement region corresponding to a front wheel of the automobile and a wheel arrangement region corresponding to a rear wheel of the automobile. More specifically, each of the pair of first column supports 31 is placed inward of the first region 101 in the X-direction (on a central side of the first cart 11 as viewed in the Y-direction). Similarly, each of the pair of second column supports 41 is placed inward of the first region 101 in the X-direction (on a central side of the second cart 21 as viewed in the Y-direction). In other words, the pair of first column supports 31 and the pair of second column supports 41 are placed between the first regions 101 away from each other in the X-direction. Naturally, the pair of first column supports 31 and the pair of second column supports 41 are placed on the second side Y2 in the Y-direction (outward in the Y-direction) from the transport object W so that the column supports do not make contact with the transport object W. In the present example, each of the first column supports 31 and the second column supports 41 is a bar-shaped member extending in the up-down direction. A first column support 31 (a front first column support 31a) on the first side X1 in the X-direction out of the pair of first column supports 31 and a second column support 41 (a front second column support 41a) on the first side X1 in the X-direction out of the pair of second column supports 41 are placed at the same position in the X-direction. Similarly, a first column support 31 (a rear first column support 31b) on the second side X2 in the X-direction out of the pair of first column supports 31 and a second column support 41 (a rear second column support 41b) on the second side X2 in the X-direction out of the pair of second column supports 41 are placed at the same position in the X-direction.

In the example of FIG. 3, the first column support 31 overlaps with the wheel holder 74 and the wheels 71 in the Y-direction. This also applies to the second column support 41. Hereby, a load acting on the column support is easily received by the wheels 71. The tow transport vehicle 7 is placed at a position deviating from the wheel holder 74 and the wheels 71 toward one side in the Y-direction (herein, the second side Y2 in the Y-direction). This avoids the wheels 71 from rolling on the magnetic tape. In the meantime, the tow transport vehicle 7 can independently travel under the cart body 72 such that the tow transport vehicle 7 does not make contact with the wheel holder 74 and the wheels 71. For example, in a case where the tow transport vehicle 7 does not need to tow the transport cart 1, the tow transport vehicle 7 can be uncoupled from the tow coupler 91 and pass under the cart body 72 to move to outside the transport cart 1. In a case where the tow transport vehicle 7 needs to tow the transport cart 1, the tow transport vehicle 7 can get under the cart body 72 from outside the transport cart 1 so that the tow transport vehicle 7 can be coupled with the tow coupler 91. In the example of FIG. 6, the first engagement section 7b is liftable and lowerable. In response to the first engagement section 7b being lowered, the first engagement section 7b is unengaged from the tow coupler 91.

As illustrated in FIG. 2 and FIGS. 4 to 6, the coupler 5 includes a first coupling member 51 coupling the first standing section 3 with the second standing section 4 on the first side X1 in the X-direction relative to the transport object W supported by the plurality of supports 6. The coupler 5 also includes a second coupling member 52 coupling the first standing section 3 with the second standing section 4 on the second side X2 in the X-direction relative to the transport object W supported by the plurality of supports 6. The first coupling member 51 couples the first column support 31 on the first side X1 in the X-direction out of the pair of first column supports 31 with the second column support 41 on the first side X1 in the X-direction out of the pair of second column supports 41. The second coupling member 52 couples the first column support 31 on the second side X2 in the X-direction out of the pair of first column supports 31 with the second column support 41 on the second side X2 in the X-direction out of the pair of second column supports 41. In other words, the first coupling member 51 couples the front first column support 31a with the front second column support 41a. The second coupling member 52 couples the rear first column support 31b with the rear second column support 41b. In the present example, the first coupling member 51 is formed to be continuous with upper ends of the front first column support 31a and the front second column support 41a. Similarly, the second coupling member 52 is formed to be continuous with upper ends of the rear first column support 31b and the rear second column support 41b. Note that the first standing section 3 may include one first column support 31, the second standing section 4 may include one second column support 41, the first coupling member 51 may couple the first column support 31 with the second column support 41 on the first side X1 in the X-direction relative to the transport object W, and the second coupling member 52 may couple the first column support 31 with the second column support 41 on the second side X2 in the X-direction relative to the transport object W.

In the present embodiment, the first coupling member 51 includes a first coupling section 51a on the first side X1 in the X-direction relative to the transport object W, and a pair of first connecting sections 51b away from each other in the Y-direction. The first coupling section 51a is a bar-shaped member along the Y-direction. One of the pair of first connecting sections 51b couples one end of the first coupling section 51a in the Y-direction with the upper end of the front first column support 31a. In the meantime, the other one of the pair of first connecting sections 51b couples the other end of the first coupling section 51a in the Y-direction with the upper end of the front second column support 41a. In the example of FIGS. 2, 6, each of the pair of first connecting sections 51b is along the X-direction and has a curved end portion on the second side X2 in the X-direction. The pair of first connecting sections 51b is placed outward of the transport object W in the Y-direction. Each of the pair of first connecting sections 51b is also a bar-shaped member.

The second coupling member 52 includes a second coupling section 52a on the second side X2 in the X-direction relative to the transport object W, and a pair of second connecting sections 52b away from each other in the Y-direction. The second coupling section 52a is a bar-shaped member along the Y-direction. One of the pair of second connecting sections 52b couples one end of the second coupling section 52a in the Y-direction with the upper end of the rear first column support 31b. The other one of the pair of second connecting sections 52b couples the other end of the second coupling section 52a in the Y-direction with the upper end of the rear second column support 41b. In the example of FIG. 2, each of the pair of second connecting sections 52b is along the X-direction and has a curved end portion on the second side X2 in the X-direction. The pair of second connecting sections 52b is placed outward of the transport object W in the Y-direction. Each of the pair of second connecting sections 52b is also a bar-shaped member. In the example illustrated herein, the first connecting sections 51b and the second connecting sections 52b are placed above the first regions 101 and do not overlap with the first regions 101 as viewed in the Y-direction. Similarly, the first coupling section 51a and the second coupling section 52a are also placed above the first regions 101. Note that, in the example illustrated herein, the first coupling member 51 and the second coupling member 52 overlap with the transport object W as viewed in the X-direction and the Y-direction, but the first coupling member 51 and the second coupling member 52 may not overlap with the transport object W as viewed in the X-direction and the Y-direction. For example, the whole coupler 5 may be placed above the transport object W.

The plurality of supports 6 is away from each other in at least the X-direction or the Y-direction. In the present embodiment, the plurality of supports 6 is away from each other in both the X-direction and the Y-direction. In the present example, the plurality of supports 6 is provided such that each of the front first column support 31a, the rear first column support 31b, the front second column support 41a, and the rear second column support 41b is provided with one support 6. Each of the supports 6 is supported in a cantilever state by a corresponding column support (a corresponding one of the pair of first column supports 31 and the pair of second column supports 41) and projects inwardly in the Y-direction (toward the first side in the Y-direction) from the corresponding column support. The plurality of supports 6 is located at the same position in the up-down direction. The plurality of supports 6 is also placed above the beams (the first beam 32, the second beam 42) but below the first coupling member 51 and the second coupling member 52. In addition, the plurality of supports 6 does not overlap with a region (a second region 102) in which the drive force source of the automobile is to be placed, a region (a third region 103) to which a suspension of the automobile is to be attached, and a region (a fourth region 104) of the bottom surface of the body to which region a component (the assembling component 120) is to be attached, as viewed vertically. Each of the plurality of supports 6 is a bar-shaped member along the Y-direction. Each of the plurality of supports 6 has a distal end portion supporting the transport object W from below. Accordingly, the distal end portion of the support 6 is wider than a portion of the support 6 which portion is on a base end side (the second side Y2 in the Y-direction) relative to the distal end portion. In the example illustrated herein, the plurality of supports 6 is placed outward of the fourth region 104 in the Y-direction.

In the example of FIG. 5, the distal end portion of each of the plurality of (herein, four) supports 6 is placed inward in the Y-direction (on the first side in the Y-direction) from the cart (the first cart 11 or the second cart 21). The transport object W supported by these supports 6 is also placed inward in the Y-direction from the first cart 11 and the second cart 21 and does not overlap with these carts as viewed vertically. In other words, the transport object W is placed in the gap 14 between the first cart 11 and the second cart 21. Note that the transport object W may overlap with at least one of the first cart 11 and the second cart 21 as viewed vertically. In the present example, the transport object W is supported by four supports 6 away from each other in the X-direction and the Y-direction, but the transport object W may be supported by three or less supports 6 or may be supported by five or more supports 6. In the present embodiment, as illustrated in FIG. 6, the plurality of supports 6 is placed at respective positions where they do not make contact with a lifting and lowering path along which the transfer support 81 lifts and lowers.

More specifically, the plurality of supports 6 is placed outward in the X-direction from the lifting and lowering path (an alternate long and short dash line) of the transfer support 81 (in the example illustrated herein, a pair of fork sections 81a away from each other in the X-direction) of the transfer device 8. Hereby, the plurality of supports 6 does not to overlap with the lifting and lowering path of the transfer support 81 as viewed vertically. Note that the plurality of supports 6 may be placed to couple the first cart 11 with the second cart 21. Thus, the supports 6 may function as the coupler 5.

As illustrated in FIGS. 4 to 6, the transport cart 1 allows the transport device 112 to be placed in a space surrounded by the first cart 11, the second cart 21, the pair of first column supports 31, the pair of second column supports 41, and the plurality of supports 6. The transport device 112 can pass through such a space on the path 9. In the present example, the transport device 112 stops at a position of the gap 14 between the first cart 11 and the second cart 21 that are stopping. The transport device 112 lifts, from below the transport object W, the assembling component 120 (such as a component in a drive force source storage chamber (for example, an engine compartment) in which a drive force source placed, or a battery for driving an electric motor or the like, for example) so as to place the assembling component 120 in a corresponding arrangement region (in the example herein, the second region 102, the fourth region 104). As illustrated in FIGS. 4, 5, one or more assembly devices 111 are provided to correspond to the stop position of the transport cart 1 and the transport device 112, so that an operation for laterally assembling the assembling component 120 in the corresponding arrangement region to the transport object W can be performed. In the present example, the operator can get on the top surface 72a of the cart body 72. Accordingly, in the operator area, the operator can perform an operation on the transport object W while the operator gets on the first cart 11 or the second cart 21. Note that the work section may be provided with an operation footstool placeable in the gap 14 between the first cart 11 and the second cart 21. In this case, the operator performs an operation on the transport object W with the use of the operation footstool. In the meantime, a conveyor that can transport the operator or the like along the path 9 may be placed. In this case, it is preferable that the conveyor be placed in the gap 14.

As illustrated in FIG. 7, the control device H can control at least the transfer device 8, the assembly device 111, the transport device 112, and the tow transport vehicle 7. As illustrated in FIG. 1, in the work section E where a plurality of mobile carts 110 moves, the control device H controls a plurality of tow transport vehicles 7 each towing a corresponding mobile cart 110 so that the plurality of mobile carts 110 is arranged appropriately along operation steps. The control device H also controls each device (the assembly device 111, the transport device 112, or the like) provided for the work section E so that the operation steps for the transport object W supported by the mobile cart 110 are performed appropriately. In response to completion of the operation steps for the transport object W supported by the mobile cart 110, the control device H controls the tow transport vehicle 7 towing the mobile cart 110, the tow transport vehicle 7 towing the transport cart 1, and the transfer device 8 so that the transport object W is transferred from the mobile cart 110 to the transport cart 1 at the transfer position P. The control device H controls a plurality of tow transport vehicles 7 in such a manner as to sequentially move the transport cart 1 on which the transport object W is placed to a subsequent work section E. Then, the control device H controls each device (for example, the assembly device 111, the transport device 112, or the like) provided for the work section E and the plurality of tow transport vehicles 7 so that the operation steps for the transport object W supported by the transport cart 1 are performed appropriately. Note that, in the transport facility 10, the transport cart 1 may be transferred onto a conveyor to move to a different work section E after the transport cart 1 is towed by the tow transport vehicle 7, for example. That is, the transport cart 1 may be transported to the different work section E by the conveyor.

### Second Embodiment

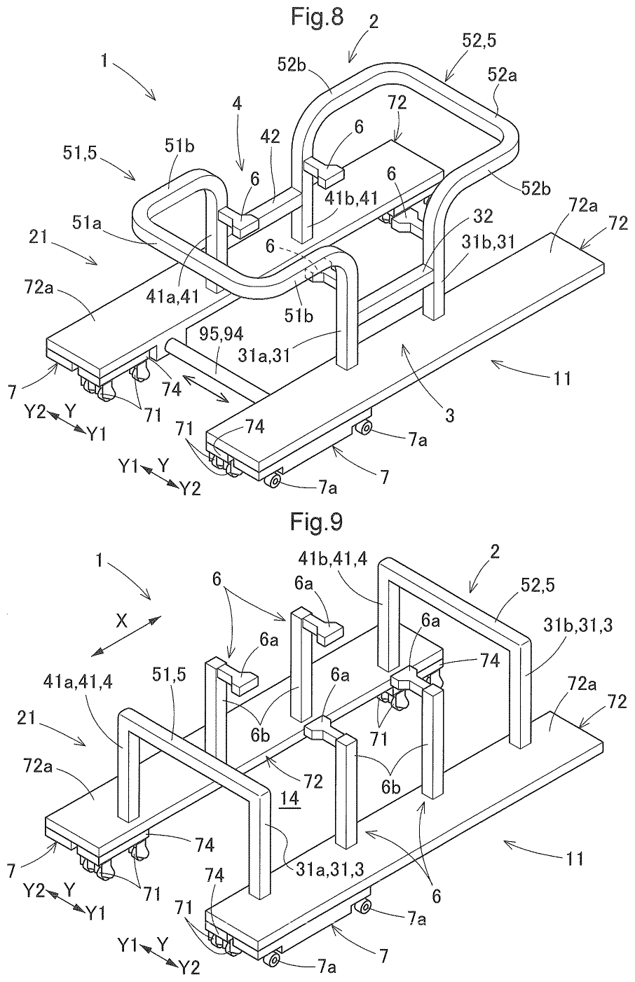

The following will describe a second embodiment of the transport cart and the transport facility with reference to a drawing (FIG. 8). The following describes mainly differences from the first embodiment in terms of the transport cart of the present embodiment. Points not particularly specified are similar to those in the first embodiment, and therefore, they are referred to as the same reference signs as used in the first embodiment and are not described specifically.

In the present embodiment, the transport cart 1 includes a coupling device 94 including a coupling member 95 configured to couple the first cart 11 with the second cart 21 at a position different from the coupler 5. The coupling device 94 is switchable between a coupled state, in which the first cart 11 is coupled with the second cart 21 by the coupling member 95, and an uncoupled state, in which the first cart 11 is uncoupled from the second cart 21. The coupler 5 couples the first cart 11 with the second cart 21 via the first standing section 3 and the second standing section 4, whereas the coupling member 95 directly couples the first cart 11 with the second cart 21. In the example of FIG. 8, the coupling member 95 couples the first cart 11 with the second cart 21 at the same height as these carts. That is, the coupling member 95 couples the first cart 11 with the second cart 21 at a position different from the coupler 5 at least in the up-down direction. In the present example, the coupling member 95 is placed along the Y-direction in the coupled state. In the meantime, the coupling member 95 is storable in either the first cart 11 or the second cart 21 in the uncoupled state. The coupling device 94 includes a drive unit (not illustrated) for moving the coupling member 95 in the Y-direction as such. Herein, the drive unit is provided for either the first cart 11 or the second cart 21.

In the example illustrated herein, the coupling member 95 is placed on the first side X1 (the front side) in the X-direction relative to the transport object W, but the coupling member 95 may be placed on the second side X2 (the rear side) in the X-direction relative to the transport object W, or a plurality of coupling members 95 may be placed on both sides of the transport object W in the X-direction. As illustrated in FIG. 7, the control device H controls the coupling device 94. In a case where the transport cart 1 moves, for example, on a curved path (in FIG. 1, the branch path 9b, the merging path 9f, the second connection path 9e), the control device H controls the coupling device 94 and switches the transport cart 1 from the uncoupled state to the coupled state.

Hereby, it is possible to reduce a load applied to the frame 2 (particularly, a load applied to the opposite end portions of the coupler 5) which load is caused due to a difference in radial travel position between the first cart 11 and the second cart 21 on the curved path.

### Other Embodiments

(1) The above embodiment has described, as an example, the configuration in which the plurality of supports 6 is provided for each of the first standing section 3 and the second standing section 4. However, the present invention is not limited to this. The plurality of supports 6 may be members provided independently from the first standing section 3 and the second standing section 4. Such an example is illustrated in FIG. 9. As illustrated in FIG. 9, the plurality of (herein, four) supports 6 is placed between the first standing section 3 and the second standing section 4 in the X-direction. Each of the supports 6 includes a support member 6a configured to support the transport object W from below, and a column support member 6b supporting the support member 6a. A plurality of (herein, two) supports 6 is away from each other in the X-direction on each of the first cart 11 and the second cart 21. In the example illustrated herein, the column support members 6b are away from each other in the X-direction on each of the first cart 11 and the second cart 21. The support member 6a is supported by the column support member 6b. More specifically, the support member 6a is supported in a cantilever state to project inward in the Y-direction (the first side Y1 in the Y-direction) from the column support member 6b. Note that, in the example illustrated herein, the first standing section 3, the second standing section 4, and the coupler 5 are placed outward in the X-direction and the Y-direction from the transport object W supported by the plurality of supports 6. Note that the first standing section 3, the second standing section 4, and the coupler 5 are modifiable appropriately. For example, as illustrated in FIG. 9, each of the first coupling member 51 and the second coupling member 52 can be a bar-shaped member along the Y-direction.

(2) The above embodiment has described, as an example, the configuration in which the first standing section 3 includes the pair of first column supports 31 away from each other in the X-direction, and the first beam 32 coupling the pair of first column supports 31 with each other, and the second standing section 4 includes the pair of second column supports 41 away from each other in the X-direction, and the second beam 42 coupling the pair of second column supports 41 with each other. However, the present invention is not limited to this. The standing section (the first standing section 3, the second standing section 4) may include no beam (the first beam 32, the second beam 42). Alternatively, only either the first standing section 3 or the second standing section 4 may include such a beam. In the present embodiment, one first beam 32 and one second beam 42 are placed along the X-direction. However, the present invention is not limited to this.

For example, a plurality of first beams 32 and a plurality of second beams 42 may be placed like a brace material. Thus, the configuration of the first beam 32 and the second beam 42 is modifiable appropriately.

(3) The above embodiment has described, as an example, the configuration in which the coupler 5 includes two coupling members, i.e., the first coupling member 51 and the second coupling member 52. However, the present invention is not limited to this. The coupler 5 may include either the first coupling member 51 or the second coupling member 52. Alternatively, the coupler 5 may include a plurality of first coupling members 51 and a plurality of second coupling members 52.

(4) The above embodiment has described, as an example, the configuration in which the tow coupler 91 is attachable to and detachable from the tow transport vehicle 7. However, the present invention is not limited to this. The tow coupler 91 may be configured to fix the tow transport vehicle 7 to the cart (the first cart 11, the second cart 21) in such a manner that the tow transport vehicle 7 can be hardly detached. Respective tow couplers 91 may be provided for respective end portions of the first cart 11 and the second cart 21 which end portions are on the first side X1 in the X-direction, and respective tow transport vehicles 7 may tow the first cart 11 and the second cart 21 from ahead. Thus, the configuration of towing by the tow transport vehicle 7 is modifiable appropriately. Alternatively, these carts may be connectable to a transport vehicle other than the tow transport vehicle 7 with the use of the tow coupler 91.

(5) The above embodiment has described, as an example, the configuration in which the drive unit of the coupling device 94 is provided for either the first cart 11 or the second cart 21, and the control device H controls the drive unit of the coupling device 94 to switch the transport cart 1 between the coupled state and the uncoupled state. However, the present invention is not limited to this. The drive unit of the coupling device 94 may not be provided for the first cart 11 and the second cart 21. For example, a robot placed laterally from the path 9 may switch the transport cart 1 between the coupled state and the uncoupled state. For example, the robot may attach the coupling member 95 to the first cart 11 and the second cart 21 and detach the coupling member 95 therefrom. The transport cart 1 may include a control unit configured to control the drive unit of the coupling device 94 based on the position of the transport cart 1, for example.

(6) The above embodiment has described, as an example, the configuration in which the transport object W is a body of an automobile. However, the present invention is not limited to this. The transport object W may be other than a body of an automobile. For example, the transport object W may be a vehicle other than an automobile, may be a body of an airplane, a drone, or the like, or may be a body including no wheel (for example, a body of a linear motor car or the like).

The transport object W may be other than a body of a vehicle. The transport object W may be, for example, a structure, a material, some device, or the like.

(7) The above embodiment has described, as an example, the configuration in which the transport facility 10 includes the transfer device 8. However, the present invention is not limited to this. The transport facility 10 may include no transfer device 8. For example, the transport facility 10 can be configured to complete all operation steps while the transport object W is put on the transport cart 1. The operation steps may not include a step performed by the operator (a step performed manually).

(8) Note that the configurations disclosed in each embodiment can be applied in combination with the configurations disclosed in other embodiments (including combinations of the embodiments described as the other embodiments) as long as no inconsistency occurs. In terms of other configurations, the embodiments disclosed in the present specification are also just examples in all respects. Accordingly, various modifications can be made appropriately as far as it does not deviate from the scope of this disclosure.

### OVERVIEW OF EMBODIMENTS

The following describes the overview of the transport cart and the transport facility described above.

A transport cart according to this disclosure is a transport cart including a first cart, a second cart arranged in parallel with the first cart, and a frame. The first cart and the second cart are away from each other in a Y-direction perpendicular to an X-direction as viewed vertically along an up-down direction, the X-direction being a particular direction among directions along a horizontal surface. The frame includes a first standing section extending upward from the first cart, a second standing section extending upward from the second cart, a coupler placed above the first cart and the second cart and coupling the first standing section with the second standing section in the Y-direction, and a plurality of supports placed above the first cart and the second cart and configured to support a transport object from below. The plurality of supports is away from each other in at least either the X-direction or the Y-direction.

In this configuration, the first cart and the second cart are away from each other in the Y-direction, which allows the transport cart to travel in such a manner that various devices or equipment can pass between the first cart and the second cart in the Y-direction as viewed from the transport cart. Accordingly, this transport cart can be easily used in various transport facilities or manufacturing facilities.

In addition, in this configuration, the plurality of supports is placed above the first cart and the second cart and supports the transport object from below. Accordingly, an operation space can be easily secured below the transport object supported by these supports. The plurality of supports is away from each other in at least either the X-direction or the Y-direction. Accordingly, a region of the bottom surface of the transport object which region is covered with the supports can be made small, thereby making it possible to easily perform an operation on the transport object from below. In consideration of such a point, this transport cart can be easily used in various transport facilities or manufacturing facilities.

As such, with this configuration, it is possible to achieve an improvement in the convenience of the transport cart for transporting a transport object.

Here, the coupler may include a first coupling member coupling the first standing section with the second standing section on a first side as one side in the X-direction relative to the transport object supported by the plurality of supports, and a second coupling member coupling the first standing section with the second standing section on a second side as the other side in the X-direction relative to the transport object supported by the plurality of supports.

In this configuration, the first coupling member and the second coupling member are away from each other to sandwich the transport object from the first side in the X-direction and the second side in the X-direction, so that the first coupling member and the second coupling member do not overlap with the transport object as viewed vertically. Accordingly, in a case where an operation is performed on the transport object from above or from below, the first coupling member and the second coupling member can be hardly obstructive.

In the configuration in which the coupler includes the first coupling member and the second coupling member as described above, the first standing section may include a pair of first column supports away from each other in the X-direction, the second standing section may include a pair of second column supports away from each other in the X-direction, the first coupling member may couple a first column support on the first side in the X-direction out of the pair of first column supports with a second column support on the first side in the X-direction out of the pair of second column supports, and the second coupling member may couple a first column support on the second side in the X-direction out of the pair of first column supports with a second column support on the second side in the X-direction out of the pair of second column supports.

In this configuration, the pair of first column supports is away from each other in the X-direction, and the pair of second column supports is away from each other in the X-direction. Accordingly, an operation can be easily performed on the transport object supported by the plurality of supports from outside in the Y-direction. Besides, the first column supports are placed on the first cart, and the second column supports are placed on the second cart. Accordingly, it is possible to easily secure a space where the transport object is placed, a space where an operation is performed on the transport object from below, or the like, for example, between the first column supports and the second column supports. While the first coupling member and the second coupling member are placed not to overlap with the transport object as viewed vertically, respective dimensions of the first coupling member and the second coupling member in the X-direction can be made small.

Each of the first cart and the second cart may include a tow coupler configured to be coupled with a tow transport vehicle including a drive source, and the tow coupler may be attachable to and detachable from the tow transport vehicle.

With this configuration, in a case where it is not necessary to move the transport cart, the tow transport vehicle can be uncoupled from the transport cart, and in a case where the transport cart is moved, the tow transport vehicle can be coupled with the transport cart. Accordingly, in comparison with a configuration in which all transport carts include respective drive sources for movement, or a configuration in which respective tow transport vehicles are coupled with all the transport carts all the time, it is possible to easily reduce the cost of the transport cart or the transport facility including the transport cart.

The transport cart may further include a coupling device including a coupling member configured to couple the first cart with the second cart at a position different from the coupler, and the coupling device may be switchable between a coupled state, in which the first cart is coupled with the second cart by the coupling member, and an uncoupled state, in which the first cart is uncoupled from the second cart.

With this configuration, in a case where it is necessary to increase stiffness of the whole transport cart, for example, when the coupled state is established by the coupling member, it is possible to reduce a load to the frame. By establishing the uncoupled state, it is possible to retract the coupling member to a position where the coupling member can be hardly obstructive to the operation.

The transport object may be a body of an automobile, the X-direction may be a direction along a longitudinal direction of the body, each of the first standing section and the second standing section may not overlap with a region of the body in which region a wheel of the automobile is to be placed, as viewed in the Y-direction, and the plurality of supports may not overlap with a region of the body in which region a drive force source of the automobile is to be placed, a region of the body to which region a suspension of the automobile is to be attached, and a region of a bottom surface of the body to which region a component is to be attached, as viewed vertically.

With this configuration, in a case where the transport object is a body of an automobile, the frame can be hardly obstructive at the time of attachment of the drive force source or the suspension of the automobile or at the time of attachment of the component to the bottom surface of the body.

A transport facility may include the transport cart, and a transfer device configured to transfer the transport object onto the transport cart at a predetermined position. The transfer device may include a transfer support configured to support the transport object from below, and a lifting and lowering mechanism configured to lift and lower the transfer support. The transfer device may be configured to transfer the transport object onto the plurality of supports by lowering the transfer support supporting the transport object toward the plurality of supports from above. Each of the plurality of supports may be placed not to overlap with a path along which the transfer support lifts and lowers.

With this configuration, in the transport facility, it is possible to transfer the transport object from the transfer support to the transport cart with a relatively simple configuration.

The transport cart and the transport facility according to this disclosure should be able to achieve at least one of the above effects.

What is claimed is:

1. A transport cart, comprising:
a first cart;
a second cart arranged in parallel with the first cart; and
a frame, and
wherein:
the first cart and the second cart are away from each other in a Y-direction perpendicular to an X-direction as viewed vertically along an up-down direction, the X-direction being a particular direction among directions along a horizontal surface,
the frame comprises:
a first standing section extending upward from the first cart;
a second standing section extending upward from the second cart;
a coupler placed above the first cart and the second cart and coupling the first standing section with the second standing section in the Y-direction; and
a plurality of supports placed above the first cart and the second cart and configured to support a transport object from below, the plurality of supports being away from each other in at least either the X-direction or the Y-direction.

2. The transport cart according to claim 1, wherein:
the coupler comprises:
a first coupling member coupling the first standing section with the second standing section on a first side as one side in the X-direction relative to the transport object supported by the plurality of supports; and
a second coupling member coupling the first standing section with the second standing section on a second side as the other side in the X-direction relative to the transport object supported by the plurality of supports.

3. The transport cart according to claim 2, wherein:
the first standing section comprises a pair of first column supports away from each other in the X-direction,
the second standing section comprises a pair of second column supports away from each other in the X-direction,
the first coupling member couples a first column support on the first side in the X-direction out of the pair of first column supports with a second column support on the first side in the X-direction out of the pair of second column supports, and
the second coupling member couples a first column support on the second side in the X-direction out of the pair of first column supports with a second column support on the second side in the X-direction out of the pair of second column supports.

4. The transport cart according to claim 1, wherein:
each of the first cart and the second cart comprises a tow coupler configured to be coupled with a tow transport vehicle comprising a drive source, and
the tow coupler is attachable to and detachable from the tow transport vehicle.

5. The transport cart according to claim 1, further comprising:
a coupling device comprising a coupling member configured to couple the first cart with the second cart at a position different from the coupler, the coupling device being switchable between a coupled state in which the first cart is coupled with the second cart by the coupling member, and an uncoupled state in which the first cart is uncoupled from the second cart.

6. The transport cart according to claim 1, wherein:
the transport object is a body of an automobile,
the X-direction is a direction along a longitudinal direction of the body,
each of the first standing section and the second standing section does not overlap with a region of the body in which region a wheel of the automobile is to be placed, and
the plurality of supports does not overlap with a region of the body in which region a drive force source of the automobile is to be placed, a region of the body to which region a suspension of the automobile is to be attached, and a region of a bottom surface of the body to which region a component is to be attached, as viewed vertically.

7. A transport facility, comprising:
the transport cart according to claim 1; and
a transfer device configured to transfer the transport object onto the transport cart at a predetermined position, the transfer device comprising a transfer support configured to support the transport object from below, and a lifting and lowering mechanism configured to lift and lower the transfer support, the transfer device being configured to transfer the transport object onto the plurality of supports by lowering the transfer support supporting the transport object toward the plurality of supports from above, and
wherein each of the plurality of supports is placed not to overlap with a path along which the transfer support lifts and lowers.
